(19) United States
(12) Patent Application Publication
(10) Pub. No.: US 2004/0232076 A1
(43) Pub. Date: Nov. 25, 2004

(54) Scouring method

(76) Inventors: Fufang Zha, Hurlstone Park (AU); Clinton V. Kopp, Bismarck, ND (US); Robert J. McMahon, Concord (AU); Warren T. Johnson, Bligh Park (AU); Thomas W. Beck, North Richmond (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/867,850

(22) Filed: Jun. 14, 2004

Related U.S. Application Data
(63) Continuation-in-part of application No. 10/369,813, filed on Feb. 18, 2003.
Application No. 10/369,813 is a continuation of application No. 09/336,059, filed on Jun. 18, 1999, now Pat. No. 6,555,005.
Application No. 09/336,059 is a continuation of application No. PCT/AU97/00855, filed on Dec. 18, 1997.
(60) Provisional application No. 60/564,827, filed on Apr. 22, 2004.
(60) Provisional application No. 60/575,462, filed on May 28, 2004.

(30) Foreign Application Priority Data
Sep. 1, 1997 (AU) PO 8918
Dec. 20, 1996 (AU) PO 4312

(51) Int. Cl. B01D 65/08

(52) U.S. Cl. 210/636; 210/615; 210/321.69

(57) ABSTRACT

The present invention relates to membrane filtration systems, and, in particular, arrangements where the membranes are supported within a tank or vessel containing the feed liquid to be filtered.

### RELATED APPLICATIONS

This application is a continuation-in-part of application Ser. No. 10/369,813, filed Feb. 18, 2003, which is a continuation of application Ser. No. 09/336,059, filed Jun. 18, 1999, now U.S. Pat. No. 6,555,005, which is a continuation, under 35 U.S.C. § 120, of International Patent Application No. PCT/AU/97/00855, filed on Dec. 18, 1997 under the Patent Cooperation Treaty (PCT), which was published by the International Bureau in English on Jul. 2, 1998, which designates the United States and claims the benefit of Australian Provisional Patent Application No. PO 4312, filed Dec. 20, 1996 and Australian Provisional Patent Application No. PO 8918, filed Sep. 1, 1997. This application claims the benefit of U.S. Provisional Application No. 60/564,827, filed Apr. 22, 2004, and U.S. Provisional Application No. 60/575,462, filed May 28, 2004.

### FIELD OF THE INVENTION

The present invention relates to the use of a gas bubble system to remove fouling materials from the surface of membranes used in filtration systems and the like.

### BACKGROUND OF THE INVENTION

A variety of membrane filtration systems are known and many of these use pressurized systems operating at high transmembrane pressures (TMP) to produce effective filtering and high filtrate flux. These systems are highly effective but are also expensive to produce, operate and maintain. Simpler systems using membrane arrays freely mounted vertically in a tank and using suction applied to the fiber lumens to produce TMP have also been developed, however, these systems have been found in the past to be less effective than the pressurized systems.

Examples of such systems are provided in U.S. Pat. No. 5,192,456 to Ishida et al, U.S. Pat. No. 5,248,424 to Cote et al and WO 97/06880 to Zenon Environmental Inc. The Ishida et al patent describes an activated sludge treating apparatus where air flow is used to clean the outer surface of the filter membrane. In this arrangement the air blower used for biological treatment of the waste water is also used as a secondary agitation source to clean the surface of the membranes. The membrane modules are of the plate type. The membranes also have a low packing density and thus do not have the problems associated with cleaning tightly packed fiber bundles. Air is bubbled from beneath the modules and is supplied externally from the membrane array. The Cote et al patent describes a system of cleaning arrays of fibers. In this case the fibers are mounted in a skein to form an inverted U-shaped or parabolic array and the air is introduced below the array to produce bubbles which contact the fibers with such force they keep the surfaces relatively free of attached microorganisms and deposits of inanimate particles. The fibers are freely swayable as they are only attached at either end and this assists removal of deposits on their outer surface. The bubbles of gas/air flow are provided from a source external of the fiber bundle and move generally transverse to the lengths of fiber. This limits the depth of fiber bundle which can be effectively cleaned.

PCT Application No. WO 97/06880 discloses unconfined fibers, vertically arranged and dimensioned to be slightly longer than the distance between the opposed faces of the headers into which the fiber ends are mounted to allow for swaying and independent movement of the individual fibers. The skein is aerated with a gas distribution means which produces a mass of bubbles which serve to scrub the outer surface of the vertically arranged fibers as they rise upwardly through the skein.

PCT Application No. WO96/07470 describes an earlier method of cleaning membranes using a gas backwash to dislodge material from the membrane walls by applying a gas pressure to the filtrate side of the membranes and then rapidly decompressing the shell surrounding the feed side of the membranes. Feed is supplied to the shell while this gas backwash is taking place to cause turbulence and frothing around the membrane walls resulting in further dislodgment of accumulated solids.

### SUMMARY OF THE INVENTION

The preferred embodiments relate particularly to a method of preventing fouling of porous fiber membranes arranged to form a membrane module arranged in a relatively tightly packed bundle. The preferred embodiments seek to overcome or at least ameliorate the problems of the prior art methods by providing a simple and effective system and method for removing fouling materials from the surface of the porous membranes by use of gas bubbles.

Accordingly, in a first embodiment a method is provided for aerating a membrane module immersed in a liquid substrate comprising the step of providing a flow of air to an aeration source below the membrane module, the flow of air alternating between a higher flow rate and a lower flow rate in repeated cycles of from greater than about 120 seconds to less than about 300 seconds in duration.

In an aspect of the first embodiment, the repeated cycles are from about 130 seconds to about 250 seconds in duration, from about 140 seconds to about 225 seconds in duration, from about 150 seconds to about 210 seconds in duration, from about 160 seconds to about 200 seconds in duration, from about 170 seconds to about 190 seconds in duration, or are about 180 seconds in duration.

In an aspect of the first embodiment, the flow of air produces transient flow conditions in the liquid substrate.

In an aspect of the first embodiment, the flow of air accelerates or decelerates the liquid substrate for much of the cycle so that the liquid substrate is rarely in a steady state.

In an aspect of the first embodiment, the aeration source comprises an aerator.

In an aspect of the first embodiment, the aeration source comprises perforated sheet.

In an aspect of the first embodiment, the aeration source comprises a jet.

In an aspect of the first embodiment, the aeration source is integral with the membrane module.

In an aspect of the first embodiment, the aeration source is separate from the membrane module.

In an aspect of the first embodiment, the lower flow rate is an air off condition.

In an aspect of the first embodiment, the lower flow rate is less than 25% of the higher flow rate, less than 40% of the higher flow rate, less than 50% of the higher flow rate, or less than 75% of the higher flow rate.

In an aspect of the first embodiment, a plurality of membrane modules are aerated.

In an aspect of the first embodiment, the liquid substrate comprises water.

In an aspect of the first embodiment, the membrane module is immersed in a tank.

In an aspect of the first embodiment, the higher flow rate corresponds to a superficial velocity in relation to the aeration source receiving the flow of air of from about 0.005 m/s to about 0.5 m/s, from about 0.010 m/s to about 0.2 m/s, or from about 0.015 m/s to about 0.15 m/s.

### BRIEF DESCRIPTION OF THE DRAWINGS

Preferred embodiments are described, by way of example only, with reference to the accompanying drawings.

FIG. 1 shows a simplified cross-sectional view of one embodiment of a membrane module in accordance with the preferred embodiments.

FIG. 2 shows a simplified two part representation of the potting arrangement of the membrane module according to one preferred embodiment.

FIG. 3 shows an enlarged view of the potting base of FIG. 2.

FIGS. 4A and 4B show the pin formations in the annular portion of the potting base and the plunger portion of the potting base, respectively.

FIG. 5 shows schematic diagram of a filtration system using the membrane module of FIG. 1.

FIG. 6 shows a simplified cross-sectional view of an alternate embodiment of the membrane module according to a preferred embodiment.

FIG. 7 shows a simplified cross-sectional view of an alternate embodiment in terms of feeding of air to the membrane module of the preferred embodiment.

FIGS. 8A and 8B shows two graphs illustrating the suction performance of the module under different conditions.

FIG. 9 shows a graph of resistance increase over time with 30 minute suction stage.

FIG. 10 shows a graph of resistance increase over time between backwashes without a porous sheet.

FIG. 11 shows a graph of resistance increase over time between backwashes with the porous sheet.

FIG. 12 shows a graph of resistance changes over time with gas bubble scouring at regular intervals but no liquid backwash of the fiber membranes.

FIG. 13 shows a similar graph to FIG. 12 illustrating the effect of no bubble scouring on backwash efficiency.

FIG. 14 shows a similar graph to FIG. 12 illustrating the effect of applying gas bubble scouring to the outer side of the fiber bundle only.

FIGS. 15a-c show a comb of tubes containing holes, the tube sitting within a module and providing pressurized gas bubbles. FIG. 15a is a front view of the comb of tubes. FIG. 15b is a top section view of the comb of tubes along Section A-A. FIG. 15c is a top isometric view of the comb of tubes.

FIG. 16 shows a module incorporating a porous sheet through which pressurized gas is supplied to provide gas bubbles.

FIG. 17 shows a schematic side elevation of one embodiment of a membrane module and illustrates the method of cleaning in a membrane bioreactor employed in the filtration apparatus of a preferred embodiment.

FIG. 18 shows an enlarged schematic side elevation of one form of the jet type arrangement used to form entrained gas bubbles of a membrane bioreactor employed in the filtration apparatus of a preferred embodiment.

FIG. 19a shows a schematic side elevation of a partitioned membrane module of a membrane bioreactor employed in the filtration apparatus of a preferred embodiment.

FIG. 19b shows a section through the membrane bundle of FIG. 19a.

FIG. 20a shows a schematic side elevation of a partitioned membrane module of a membrane bioreactor employed in the filtration apparatus of a preferred embodiment.

FIG. 20b shows a section through the membrane bundle of FIG. 20a.

FIG. 21a shows a schematic side elevation of a partitioned membrane module of a membrane bioreactor employed in the filtration apparatus of a preferred embodiment.

FIG. 21b shows a section through the membrane bundle of FIG. 21a.

FIG. 22a shows a schematic side elevation of a partitioned membrane module of a membrane bioreactor employed in the filtration apparatus of a preferred embodiment.

FIG. 22b shows a section through the membrane bundle of FIG. 22a.

FIG. 23 shows a section through a membrane module of a preferred embodiment.

FIG. 24 shows a section through a membrane module of a preferred embodiment.

FIG. 25 shows a sectioned perspective pictorial view of the lower end of another preferred embodiment of the membrane module of a membrane bioreactor employed in the filtration apparatus of a preferred embodiment.

FIG. 26 shows a sectioned perspective pictorial view of the upper end of the membrane module of FIG. 25.

FIG. 27 depicts a hollow fiber membrane module employed in a membrane bioreactor employed in the filtration apparatus of a preferred embodiment.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

### Filtration Systems

The filtration and aeration methods described herein are advantageously employed in membrane filtration system employing modules or cassettes of hollow fibers suspended in a tank. Such systems can be employed for water treatment (e.g., aerobic, anaerobic, or non-aerobic systems), or for filtration of any suitable liquid substrate. The systems are particularly preferred for use in conjunction with membrane bioreactor systems. Membrane bioreactor systems combine biological treatment, involving bacteria, with membrane separation to treat wastewater. Treated water is separated from the purifying bacteria, referred to as activated sludge, by a process of membrane filtration. Membrane bioreactors preferably employ submerged hollow fiber membrane modules incorporated in a distributed flow reactor.

Membrane processes can be used for drinking water treatment or for effective tertiary treatment of sewage to provide quality effluent. Submerged membrane processes where the membrane modules are immersed in a large feed tank and filtrate is collected through suction applied to the filtrate side of the membrane, and wherein the membrane bioreactor combines biological and physical processes in one stage, are compact, efficient, economic, and versatile.

The processes described herein can be modified or adapted to accommodate various membrane module or cartridge systems as are commercially available, such as those commercially available from USFilter Memcor Research Pty. Ltd. Membrane modules and cartridges, and related systems, devices, and methods, are described, for example, in U.S. Pat. No. 5,639,373, U.S. Pat. No. 5,783,083, U.S. Pat. No. 5,910,250, U.S. Pat. No. 5,944,997, U.S. Pat. No. 6,042,677, U.S. RE37,549, U.S. Pat. No. 6,193,890, U.S. Pat. No. 6,294,039, U.S. Pat. No. 6,620,319, U.S. Pat. No. 6,685,832, U.S. Pat. No. 6,682,652, U.S. Pat. No. 6,319,411, U.S. Pat. No. 6,375,848, U.S. Pat. No. 6,245,239, U.S. Pat. No. 6,325,928, U.S. Pat. No. 6,550,747, U.S. Pat. No. 6,656,356, U.S. Pat. No. 6,708,957, U.S. Pat. No. 6,706,189, U.S. Publ. No. 2004-0035780-A1, U.S. Publ. No. 2003-0164332-A1, U.S. Publ. No. 2002-0130080-A1, U.S. Publ. No. 2002-0179517-A1, U.S. Publ. No. 2004-0007527 A1, U.S. Pat. No. 5,918,264, U.S. Pat. No. 6,159,373, U.S. Pat. No. 6,077,435, U.S. 6,156,200, U.S. Pat. No. 6,254,773, U.S. Pat. No. 6,202,475, U.S. Design Patent 478913, U.S. Design Patent 462699, and U.S. Pat. No. 6,524,481, the contents of which are hereby incorporated by reference in their entirety.

The membrane bioreactor systems preferably employed in the preferred embodiments utilize an effective and efficient membrane cleaning method. Commonly used physical cleaning methods include backwash (backpulse, backflush) using a liquid permeate and/or a gas, membrane surface scrubbing, and scouring using a gas in the form of bubbles in a liquid. Examples of the second type of method are described in U.S. Pat. No. 5,192,456 to Ishida et al., U.S. Pat. No. 5,248,424 to Cote et al., U.S. Pat. No. 5,639,373 to Henshaw et al., U.S. Pat. No. 5,783,083 to Henshaw et al., and U.S. Pat. No. 6,555,005 to Zha et al.

In many membrane bioreactor systems, a gas is injected, typically by a pressurized blower, into a liquid system where a membrane module is submerged to form gas bubbles. The bubbles so formed then travel upwards to scrub the membrane surface to remove the fouling substances formed on the membrane surface. The shear force produced largely relies on the initial gas bubble velocity and bubble size.

The membrane bioreactor can include a tank having a line, a pipe, a pump, and or other apparatus for the introduction of feed thereto, an activated sludge within the tank, a membrane module positioned within the tank so as to be immersed in the sludge, and apparatus for withdrawing filtrate from at least one end of the fiber membranes.

The membrane bioreactor is preferably operated by introducing feed to the tank, applying a vacuum to the fibers to withdraw filtrate therefrom while intermittently, cyclically, or continuously supplying gas bubbles through the aeration openings to within the module such that, in use, the bubbles move past the surfaces of the membrane fibers to dislodge fouling materials therefrom. Preferably, the gas bubbles are entrained or mixed with a liquid flow when fed through the holes or slots.

If desired, a further source of aeration can be provided within the tank to assist microorganism activity. Preferably, the membrane module is suspended vertically within the tank and the further source of aeration can be provided beneath the suspended module. Alternatively, the module can be suspended horizontally, or in any other desired position. Preferably, the further source of aeration comprises a group of air permeable tubes, a porous sheet or grating, or other such aeration source or apparatus. The membrane module can be operated with or without backwash, depending on the flux.

A mixed liquor of high suspended solids (about 5,000 ppm or less to about 20,000 ppm or more) can be filtered according to the methods of preferred embodiments. The combined use of aeration for both degradation of organic substances and membrane cleaning is an efficient method of operation that enables constant filtrate flow without significant increase in transmembrane pressure. The use of partitioned fiber bundles enables higher packing densities to be achieved without significantly compromising the gas scouring process. This provides for higher filtration efficiencies to be gained.

### The Membrane Module

For most tubular membrane modules, the membranes are flexible in the middle (longitudinal directions) of the modules but tend to be tighter and less flexible towards to both potted heads. When such modules are used in an environment containing high concentrations of suspended solids, solids are easily trapped within the membrane bundle, especially in the proximity of two potted heads. The methods to reduce the accumulation of solids include the improvement of module configurations and flow distribution when gas scrubbing is used to clean the membranes.

In the design of a membrane module, the packing density of the tubular membranes in a module is one factor that is considered. The packing density of the fiber membranes in a membrane module as used herein is defined as the cross-sectional potted area taken up by the fiber membranes divided by the total potted area and is normally expressed as a percentage. From the economical viewpoint it is desirable that the packing density be as high as possible to reduce the cost of making membrane modules. In practice, solid packing is reduced in a less densely packed membrane module. However, if the packing density is too low, the rubbing effect between membranes can also be lessened, resulting in less efficient scrubbing/scouring of the membrane surfaces. It is thus desirable to provide a membrane configuration that assists removal of accumulated solids while maximizing packing density of the membranes. The membranes can be in contact with each other (e.g., at high packing densities), or can be closely or distantly spaced apart (e.g., at low packing densities), for example, a spacing between fiber walls of from about 0.1 mm or less to about 10 mm or more is typically employed.

Typically, the fibers within the module have a packing density (as defined above) of from about 5% or less to about 75% or more, preferably from about 6, 7, 8, 9, or 10% to about 60, 65, or 70%, and more preferably from about 11, 12, 13, 14, 15, 16, 17, 18, 19, or 20% to about 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55%.

Preferably, the aeration holes have a diameter of from about 0.5 mm or less to about 50 mm or more, more preferably from about 0.6, 0.7, 0.8, 0.9, 1.0, 1.1, 1.2, 1.3, 1.4, or 1.5 to about 25, 30, 35, 40, or 45 mm, and most preferably from about 1.75, 2.0, 2.5, 3.0, 3.5, 4.0, 4.5, or 5.0 mm to about 6, 7, 8,9, 10, 11, 12, 13, 14, 15, 16, 17, 18, 19, 20, 21, 22, 23, or 24 mm. In the case of a slot or row of holes, the minimum or maximum diameter of the opening is typically chosen to be similar to that of the holes described above.

Typically, the fibers' inner diameter is from about 0.05 mm or less to about 10 mm or more, preferably from about 0.10, 0.15, or 0.20 mm to about 3, 4, 5, 6, 7, 8, or 9 mm, and preferably from about 0.25, 0.50, 0.75, or 1.0 mm to about 1.25, 1.50, 1.75, 2.00, or 2.50 mm. The fibers wall thickness can depend on materials used and strength required versus filtration efficiency. Typically, wall thickness is from about 0.01 mm or less to about 3 mm or more, preferably from about 0.02, 0.03, 0.04, 0.05, 0.06, 0.07, 0.08, or 0.09 mm to about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or 2.9 mm, and most preferably from about 0.1, 0.2, 0.3, 0.4, or 0.5 mm to about 0.6, 0.7, 0.8, 0.9, or 1 mm.

Scrubbing a membrane surface can be accomplished using a liquid medium with gas bubbles entrained therein, wherein the gas bubbles are entrained into a liquid medium by flow of the liquid medium past a source of the gas, and then the gas bubbles and liquid medium are flowed along the membrane surface to dislodge fouling materials therefrom, can be employed in membrane bioreactors. Preferably, the gas bubbles are entrained into the liquid stream by a venturi device or other type of junction. For further preference, the gas bubbles are entrained or injected into the liquid stream by means of devices which forcibly mix gas into a liquid flow to produce a mixture of liquid and bubbles, such devices including a jet, nozzle, ejector, eductor, injector or the like. Optionally, an additional source of bubbles can be provided in the liquid medium by means of a blower or like device.

The gas used can include, for example, air, nitrogen oxygen, gaseous chlorine, ozone, and the like. Air is the most economical for the purposes of scrubbing and/or aeration. Gaseous chlorine can be used for scrubbing, disinfection, and enhancing the cleaning efficiency by chemical reaction at the membrane surface. The use of ozone, besides the similar effects mentioned for gaseous chlorine, has additional features, such as oxidizing disinfectant by-product (DBP) precursors and converting non-biodegradable Natural Organic Matter (NOM) to biodegradable dissolved organic carbon.

The membrane modules preferably comprise a plurality of porous membranes arranged in close proximity to one another, optionally mounted to prevent excessive movement therebetween, and include a source of gas bubbles for providing, from within the module gas bubbles entrained in a liquid flow such that, in use, the liquid and bubbles entrained therein move past the surfaces of the membranes to dislodge fouling materials therefrom, the gas bubbles being entrained in the liquid by flowing the liquid past a source of gas to draw the gas into the liquid flow. Preferably, the liquid and bubbles are mixed and then flowed past membranes to dislodge the fouling materials.

The fibers of the membrane bioreactor can be cleaned by providing, from within the array of fibers, by means other than gas passing through the pores of the membranes, uniformly distributed gas-bubbles entrained in a liquid flow, the gas bubbles being entrained in the liquid flow by flowing the liquid past a source of gas so as to cause the gas to be drawn and/or mixed into the liquid, the distribution being such that the bubbles pass substantially uniformly between each membrane in the array to, in combination with the liquid flow, scour the surface of the membranes and remove accumulated solids from within the membrane module. Preferably, the bubbles are injected and mixed into the liquid flow.

Preferably, the membranes of the membrane bioreactor comprise porous hollow fibers, the fibers being fixed at each end in a header, the lower header having one or more holes formed therein through which gas liquid flow is introduced. The holes can be circular, elliptical or in the form of a slot. The fibers are normally sealed at the lower end and open at their upper end to allow removal of filtrate, however, in some arrangements, the fibers can be open at both ends to allow removal of filtrate from one or both ends. The fibers are preferably arranged in cylindrical arrays or bundles, however other configurations can also be employed, e.g., square, hexagonal, triangular, irregular, and the like. It is appreciated that the cleaning process described is equally applicable to other forms of membrane such flat or plate membranes that can also be employed in membrane bioreactors.

The membrane modules preferably comprise a plurality of porous hollow fiber membranes, the fiber membranes being arranged in close proximity to one another and mounted to prevent excessive movement therebetween, the fiber membranes being fixed at each end in a header, one header having one or more of holes formed therein through which gas/liquid flow is introduced, and partition means extending at least part way between the headers to partition the membrane fibers into groups. Preferably, the partition or partitions are formed by a spacing between respective fiber groups, however porous (e.g., a screen, clip, or ring) or solid partitions can also be employed. The partitions can be parallel to each other or, in the case of cylindrical arrays of fiber membranes, the partitions can extend radially from the center of the array or be positioned concentrically within the cylindrical array. In an alternative form, the fiber bundle can be provided with a central longitudinal passage extending the length of the bundle between the headers.

The membrane modules of preferred embodiments preferably include a plurality of porous hollow membrane fibers extending longitudinally between and mounted at each end to a respective potting head, the membrane fibers being arranged in close proximity to one another and mounted to prevent excessive movement therebetween, the fibers being partitioned into a number of bundles at least at or adjacent to their respective potting head so as to form a space therebetween, one of the potting heads having an array of aeration openings formed therein for providing gas bubbles within the module such that, in use, the bubbles move past the surfaces of the membrane fibers to dislodge fouling materials therefrom.

The fiber bundle can be protected and fiber movement can be limited by a module support screen which has both vertical and horizontal elements appropriately spaced to provide unrestricted fluid and gas flow through the fibers and to restrict the amplitude of fiber motion reducing energy concentration at the potted ends of the fibers. Alternatively, clips or rings can also be employed to bind the fiber bundle. In certain embodiments, however, it can be desirable not to protect the fiber bundle or to limit fiber movement.

Preferably, the aeration openings are positioned to coincide with the spaces formed between the partitioned bundles. Preferably, the openings comprise one or more holes or slots, which can be arranged in various configurations, e.g., a row of holes. Preferably, the fiber bundles are located in the potting head between the slots or rows of holes. In certain embodiments, it can be preferred to situate the holes or slots within the fiber bundles, or both within and adjacent to the fiber bundles.

Preferably, the gas bubbles are entrained or mixed with a liquid flow before being fed through the holes or slots, though it is appreciated that gas only can be used in some configurations. The liquid used can be the feed to the membrane module. The fibers and/or fiber bundles can cross over one another between the potting heads though it is desirable that they do not.

While it is generally preferred to introduce scouring or aeration bubbles into the module under pressure or entrained in a fluid flow, in some embodiments it can be preferred to permit the bubbles to rise through the substrate under their own buoyancy. Any suitable apparatus for distributing the air bubbles can be employed, e.g., a grating, screen, or porous sheet under which gas is introduced, a tube, pipe, or other hollow structure having holes or other egresses for gas, nozzles, and the like. While it is generally preferred to have aeration openings in the membrane module, in certain embodiments the source of aeration to the modules can be positioned elsewhere within the reactor, e.g., below the modules, adjacent to the modules.

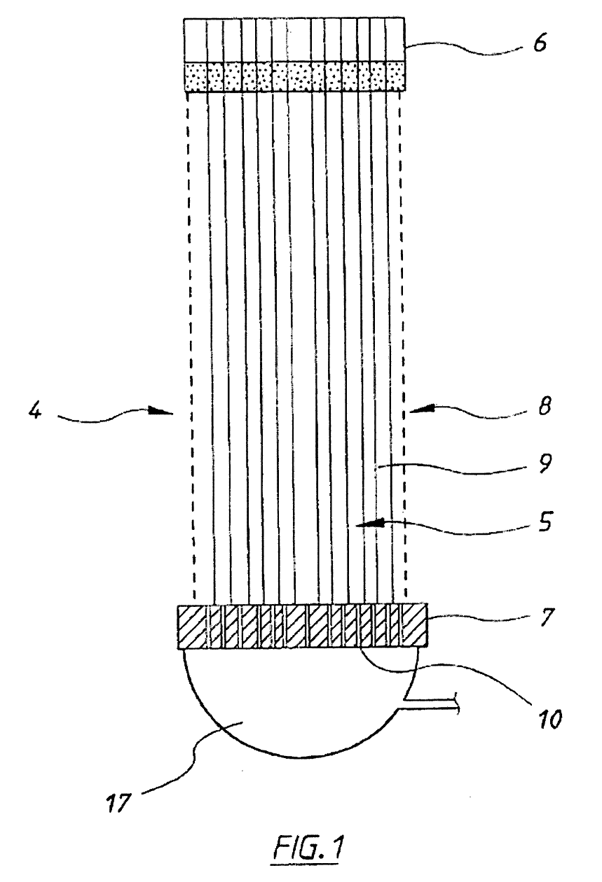

Referring to FIG. 1, the membrane module 4, according to this embodiment, comprises a cylindrical array or bundle of hollow fiber membranes 5 extending longitudinally between upper and lower potting heads 6, 7. Optionally, a screen or cage 8 surrounds the array 5 and serves to hold the fibers 9 in close proximity to each other and prevent excessive movement. The fibers 9 are open at the upper potting head 6 to allow for filtrate removal from their lumens and sealed at the lower potting head 7. The lower potting head 7 has a number of holes 10 uniformly distributed therein to enable gas/air to be supplied therethrough. The fibers are fixed uniformly within the potting heads 6 and 7 and the holes 10 are formed uniformly relative to each fiber 9 so as to provide, in use, a uniform distribution of gas bubbles between the fibers.

The holes are formed as part of the potting process as described below. The arrangement of the holes relative to one another as well as the arrangement of fibers relative to the holes and each other has been found to affect the scouring efficiency of the gas bubbles.

The maldistribution of gas within the fiber bundle can be overcome by appropriate distribution and sizing of holes to ensure that bubble flow around the fibers is uniform across the bundle. In a cylindrical bundle of closely packed fibers it has been found that the distance traveled through the bundle by bubbles introduced towards the center of the bundle is larger than those introduced towards the outer extremity of the bundle, resulting in a higher resistance to bubble flow at the center of the bundle than at its border or periphery.

As outlined above, one method of addressing the maldistribution of gas bubbles is to provide a porous sheet (not shown) across the holes to provide an even pore distribution and thus a uniform gas flow. Another method is to provide a distribution of hole size relative to the distribution of resistance. Since the gas flow rate (Q) per unit area (A) is inversely proportional to the resistance (R),

Q/A˜1/R

the relationship between the hole diameter (d) and the resistance becomes

d˜(R)^{1/2}

using the above relationship it is possible to design a hole size and position configuration which compensates for resistance differences within the bundle. For example, if the resistance at the center of the bundle is 50% higher than that at its periphery, the hole size at the center (d_{c}) and on the periphery (dₚ) is the following for a uniform distribution of gas:

d_{c}/dₚ=1.5^{0.5}=1.22

Known methods of forming holes require the drilling of holes or other forms of post-potting formation. Such methods have the disadvantage of requiring avoidance of the fibers/membranes when drilling or the like to avoid damage. This imposes limitations on the fiber packing density and hole size as, where fibers are tightly packed, it very difficult to drill holes without interfering with or damaging the fibers. Further, it is difficult to accurately locate holes relative to the fibers/membranes.

The process used in one aspect seeks to overcome or at least the ameliorate the problems and disadvantages outlined above.

According to this aspect, a method is provided for forming openings in a membrane pot for use in gas distribution comprising the steps of: providing a mould for potting membrane ends, the mould having provided therein formations for forming the openings during the potting process; positioning the membrane ends in the mould which is filled with a curable potting material; allowing the potting material to at least partially cure and, demoulding the membranes.

Preferably, the membranes ends are uniformly distributed in relation to the formations. In another aspect, a membrane assembly is provided including at least one membrane pot formed according to the above method.

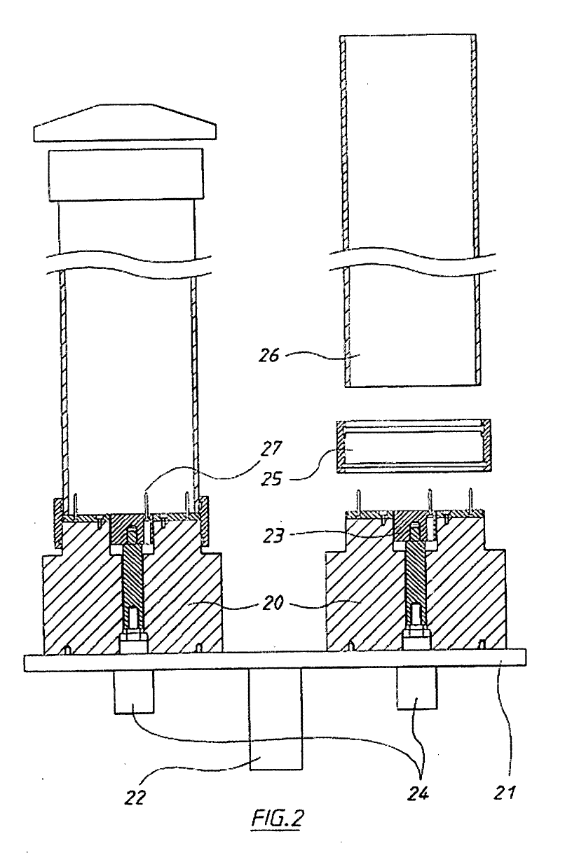

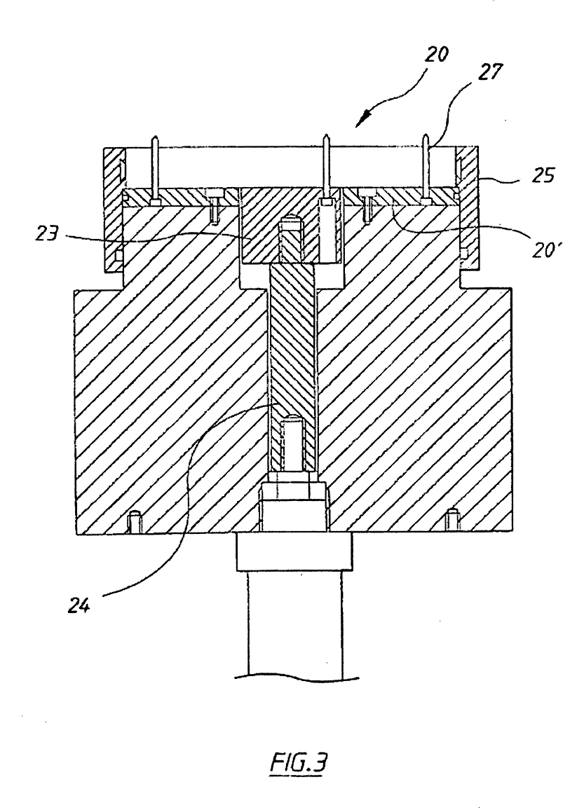

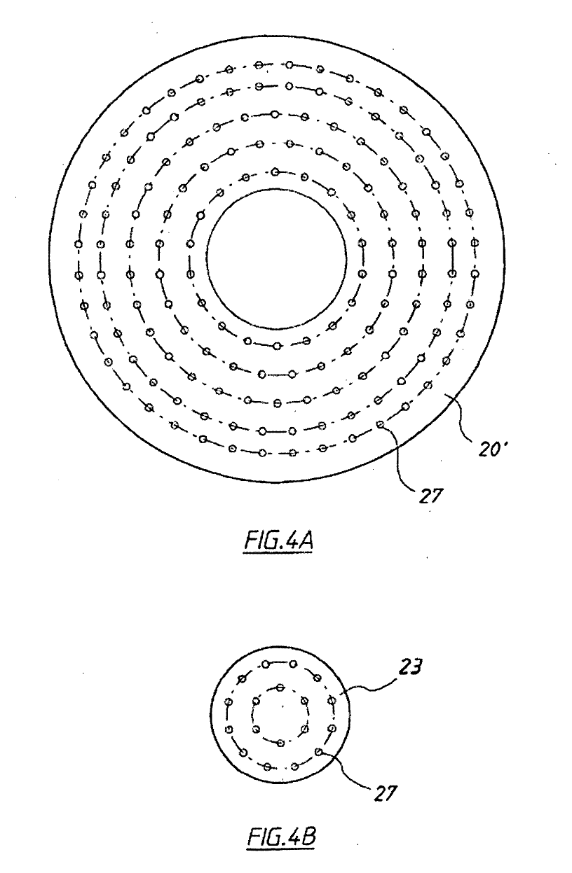

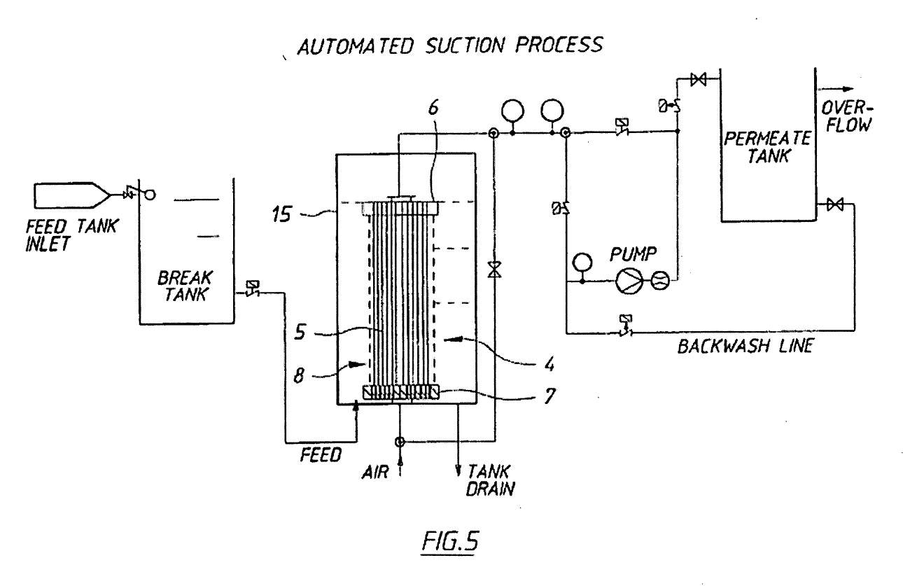

Referring to FIGS. 2-4, the preferred method of forming the gas distribution holes is described. As shown in the right side part of FIG. 2, the potting apparatus (shown empty) comprises a potting mould 20 mounted on a vertically movable platform 21 which is raised and lowered by means of hydraulic cylinder 22. The center of each mould 20 is provided with a vertically movable ejector plunger 23 operated by and hydraulic ejector cylinder 24. A fiber guide or collar 25 fits around the periphery of the mould to guide and hold the fiber ends during the potting process as well as retaining the potting mixture, typically polyurethane, within the mould. The fibers are held within a sleeve 26 when inserted into the guide 25. The base 20′ of the mould 20 has a plurality of upstanding pins 27 which serve the dual purpose of assisting even distribution of the fiber ends and forming the gas distribution holes in the pot. The pins are sized and distributed as required for correct gas bubble distribution. One form of pin distribution is shown in FIG. 4.

In use, the guide 25 is placed about the mould 20 and the mould 20 filled to the required level with potting material. The platform 21 is then raised to lower the fiber ends into the mould 20. The fiber ends are normally fanned before insertion to ensure even distribution and also trimmed to ensure a uniform length.

Once the potting material has partially cured, the pot is ejected from the mould by raising the central ejector portion 23 of the mould. The mould 20 is normally heated to assist curing. If desired, the mould 20 can be centrifuged during the potting process to assist the penetration of the potting material into the fiber walls.

This process normally results in the ends of the fibers in this pot being sealed, however, it is appreciated that, by appropriate transverse cutting of the pot, the fiber ends can be opened for withdrawal of filtrate from the lumens.

A trial module 4 of this type was packed with 11,000 fibers (o.d./i.d. 650/380 μm). The fiber lumens at the lower end were blocked with polyurethane and 60 holes of 4.5 mm in diameter distributed within the fiber bundle. The lower end was connected to an air line sealed from the feed.

FIG. 5 illustrates the setup of the trial unit. The module 4 was arranged vertically in the cylinder tank 15 and the filtrate withdrawn from the top potting head 6 through suction. Air was introduced into the bottom of the module 4, producing air bubbles between fibers to scrub solids accumulated on membrane surfaces. To remove solids clogged within membrane pores, a small quantity of permeate was pumped through fiber lumens (permeate backwash). One method of operation was to run suction for 15 minutes, then aeration for 2 minutes 15 seconds. After a first minute of aeration, a permeate backwash is introduced for 15 seconds. The cycle returns to suction. After several cycles, the solids in the cylinder tank 15 were concentrated and the water in the tank 15 was drained down to remove concentrated backwash.

In the preferred embodiment shown in FIG. 1, gas/air should be uniformly distributed and flow through the small holes 10 at the lower end of the module 4 so that air bubbles can be produced between fibers 9. Air bubbles then flow upwards producing shear force to scour solids accumulated on the membrane surfaces. If the resistance around the holes 10 is variable due to varying resistance provided by different regions of the fiber bundle, gas/air will tend to flow through those holes associated with a lower resistance, resulting in by-pass flow through these holes.

In the manufacture of membrane modules 4, it is desirable to pot the fibers 9 in a uniform distribution relative to the holes 10. Moreover, smaller and more holes will help distribution of gas/air, but holes that are too small will reduce bubble size and thus the shear force applied to the outer surface of the fibers. It is preferable that size of holes should be within the range of 0.01 to 5 mm, however, it is appreciated that the size and position of holes 10 will vary with module size, fiber packing density, fiber diameter, fiber pore size and other factors.

Another way to reduce maldistribution of gas/air is to use a layer of porous sheet (not shown) which has much smaller pore size than the holes 10. In this case, the major pressure drop of air is across the porous sheet. If the porous sheet has uniformly distributed pores, the air distribution across the air end of the module will tend to be evenly spread.

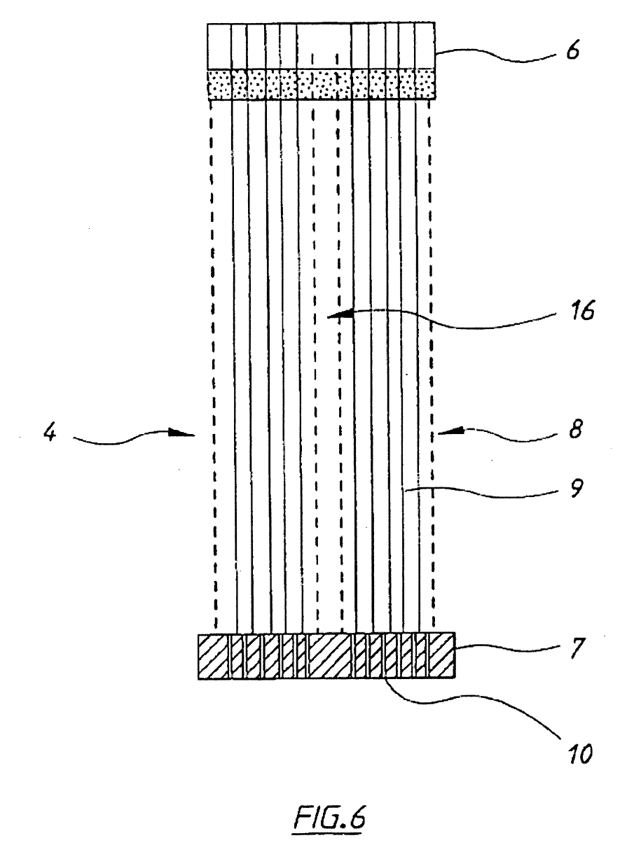

To further improve distribution of air bubbles, a porous tube 16 can be inserted in the center of the cylindrical module 4. When air passes through porous tube 16, it produces uniform bubbles which pass out through the array of fibers scouring solids on the fiber membrane walls. It is appreciated that more than one porous tube can be used and such tubes can be distributed throughout the bundle. Fibers of large pore size or made of non-woven material can also be used as porous tubes within the bundle. FIG. 6 illustrates this form of module.

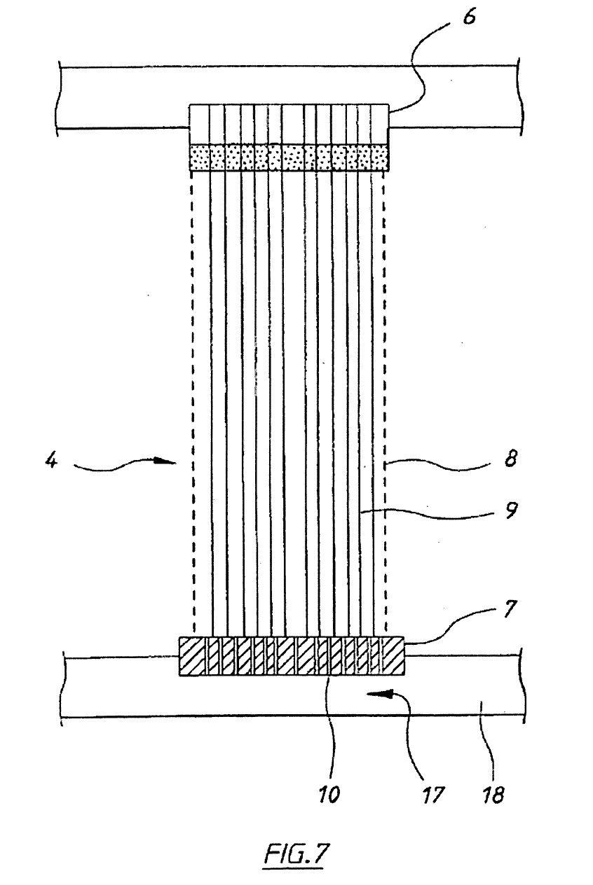

Referring to FIG. 7, air can be fed into a plenum chamber 17 below the aeration holes 10 by an air supply tube running from above the feed tank to the bottom of the membrane module. This tube can run down the center of the membrane module or down the outside. The plenum chamber 17 can also be connected to or form part of a lower manifold 18 which can be used alternately for supply of aeration gas or as a liquid manifold for removal of concentrated backwash liquid from the tank during draindown or backwashing from the bottom of the module.

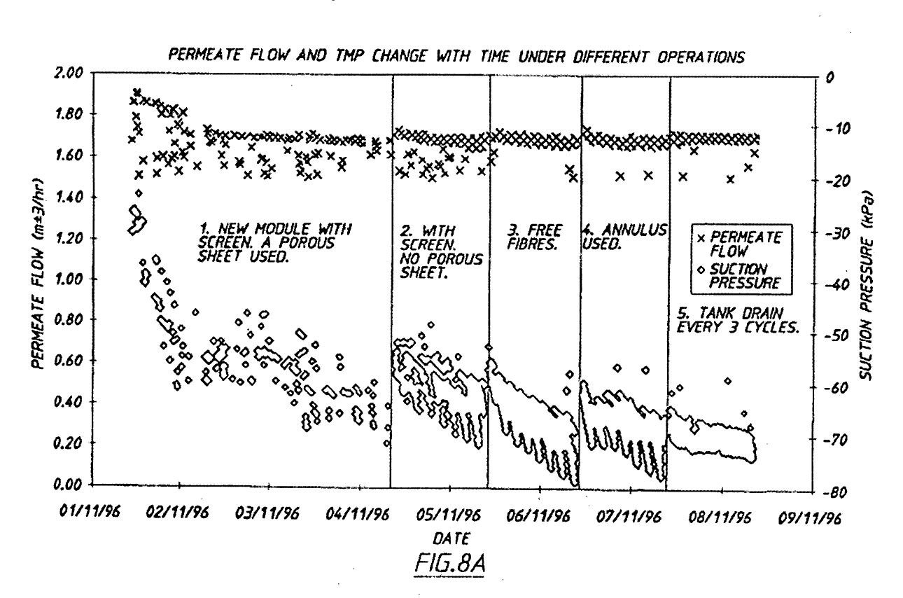

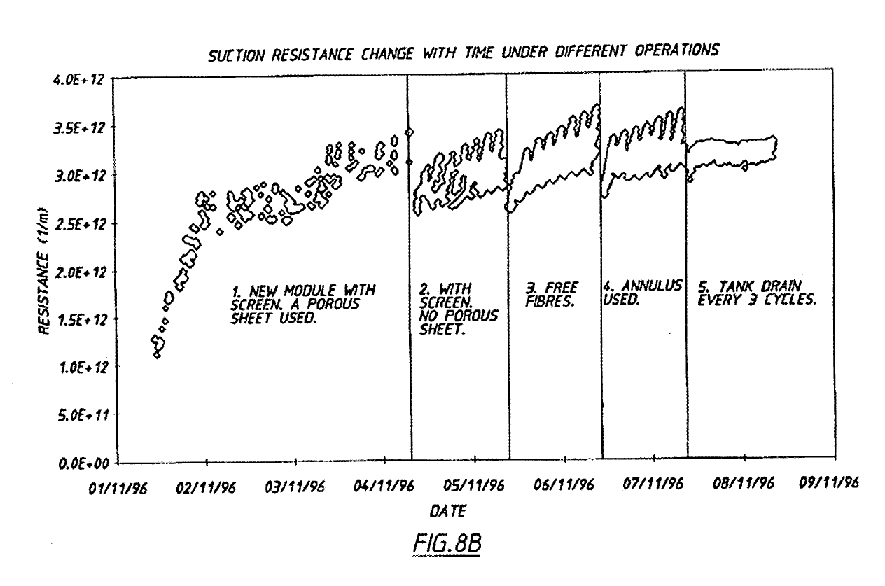

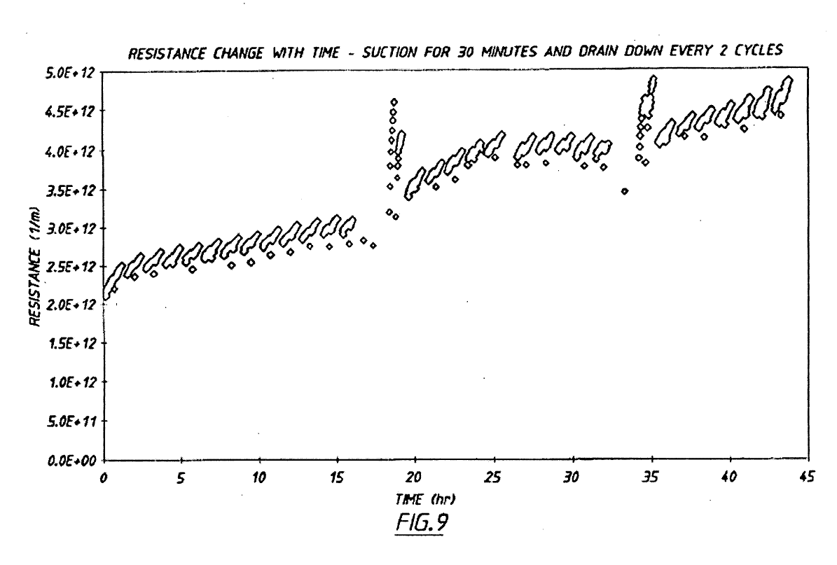

FIGS. 8A and 8B shows the trial results of the same module under different conditions labeled by several zones. The water in the cylinder tank was drained down every 10 cycles in zones 1 to 4. The discharge rate of concentrated liquid waste is thus calculated as 3.2% of the feed volume. Zone 5 was run under the discharge of liquid waste every 3 cycles at a rate of 10.2% of the feed.

Zones 1 and 2 compare the effect of using a porous sheet at the air end on the suction performance for the module with a screen surrounding the fiber bundle. Initially the suction pressure decreased (i.e. TMP increased) quickly because of the module was new. Then both suction pressure and resistance tended to be stable. By comparison, the increase in suction resistance was faster after removing the porous sheet as illustrated in Zone 2. These results illustrate that the air end combined with a porous sheet helps to distribute air between fibers.

The use of the screen 8 has a dual effect on filtration. The restriction of fiber movement by screen facilitates solid accumulation during suction. On the other hand, limited free space between fibers reduces coalescence of air bubbles, producing better scouring effect. It has also been found that the restriction of fiber movement in conjunction with the movement of gas bubbles produces high frequency vibrations in the fibers and rubbing between the closely packed fiber surfaces which further improves the removal of accumulated solids. Zones 3 and 4 in FIGS. 8A and 8B represent results for the same modules with and without a screen.

During the operation in Zone 3 some by-pass of air bubbles was observed. This was due to different resistance around the aeration holes, especially on the border where comparatively fewer fibers were distributed around those holes. We therefore used a porous annulus sheet covering holes at the outer border of the lower potting head. Results in Zone 4 show the improvement compared to Zone 3.

Solid concentration is an important issue to filtration and fouling rate. When a tank drain was carried out every 10 cycles, solids were built up quickly, which influenced filtration performance. When the tank was drained down every 3 cycles, the increase in suction resistance was significantly reduced as reflected in Zone 5.

The frequency of air scrubbing and backwash on the filtration performance was also investigated. FIG. 9 shows the resistance increase for 30 minute suction and then backwash and air scrubbing. Compared with the resistance increase in Zone 5 in FIG. 8, resistance increase was faster when suction time was longer between backwashes.

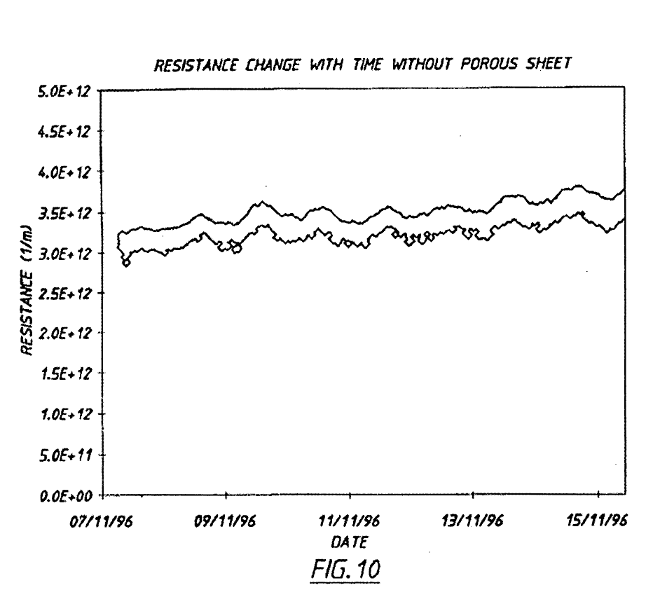

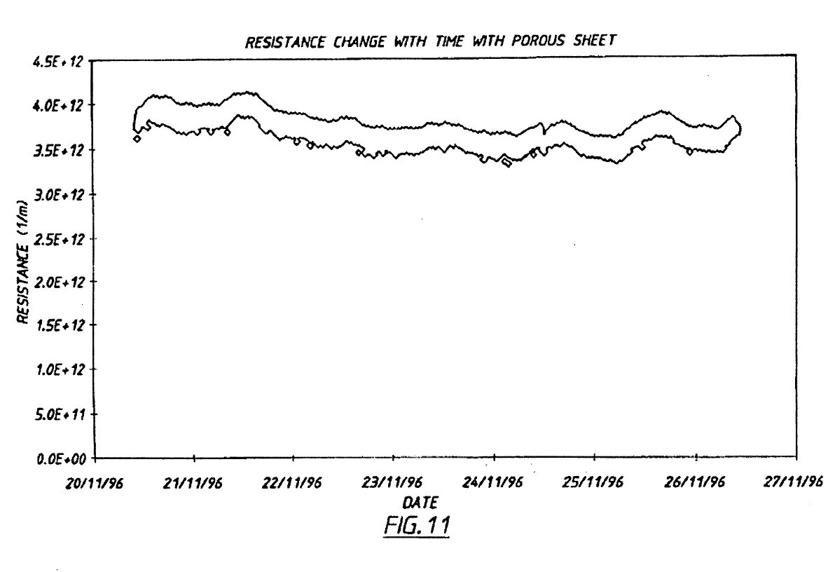

Longer term trials were conducted to compare the effect of porous sheet on suction performance. FIGS. 10 and 11 show the resistance increase for more than 6 days operation, with and without the porous sheet. For the module not connected to a porous sheet, suction resistance increased slowly by ca. 20% during 8 days, while no obvious resistance increase during 6 days operation when a porous sheet was used to improve air distribution. These results and the result shown in Zones 1 and 2 in FIG. 8 suggest that a porous sheet helps uniform air distribution.

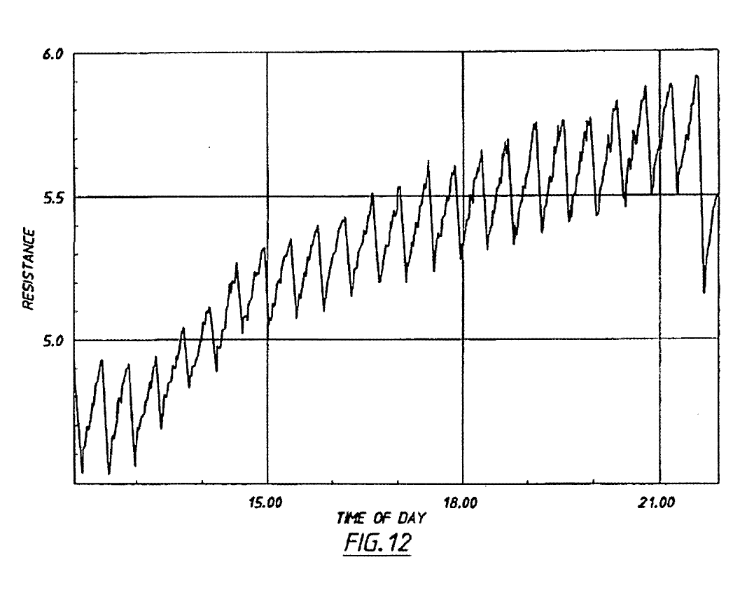

FIGS. 12-14 are graphs which illustrate the effect of the bubble scouring on backwash efficiency. The scouring is conducted a regular intervals as shown the buildup of resistance followed by a sharp decline at the time of the scouring stage.

FIG. 12 shows the effect of not using a liquid backwash in conjunction with the gas scouring. At the beginning of the test a normal liquid backwash where filtrate is pumped back through the fiber lumens as a liquid backwash in conjunction with the gas scouring along the outside of the fibers. The liquid backwash was then stopped and only regular gas scouring was used. It was found that even without the liquid backwash a backwash efficiency of around 90% can be achieved.

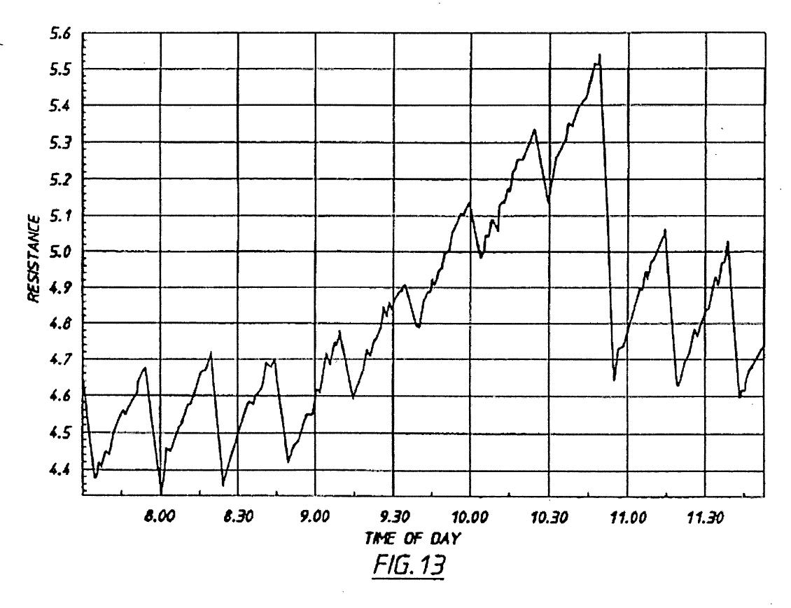

FIG. 13 shows the effect of no gas scouring during the backwash phase. Again the initial part of the test used a normal liquid backwash where filtrate is pumped back through the fiber lumens as a liquid backwash in conjunction with the gas scouring along the outside of the fibers. The gas scouring was then stopped between about 9:15 and 10:45. As shown on the graph the backwash efficiency dropped dramatically from about 96% using gas scouring to about 41% without gas scouring. The return of gas scouring showed a marked improvement in backwash efficiency.

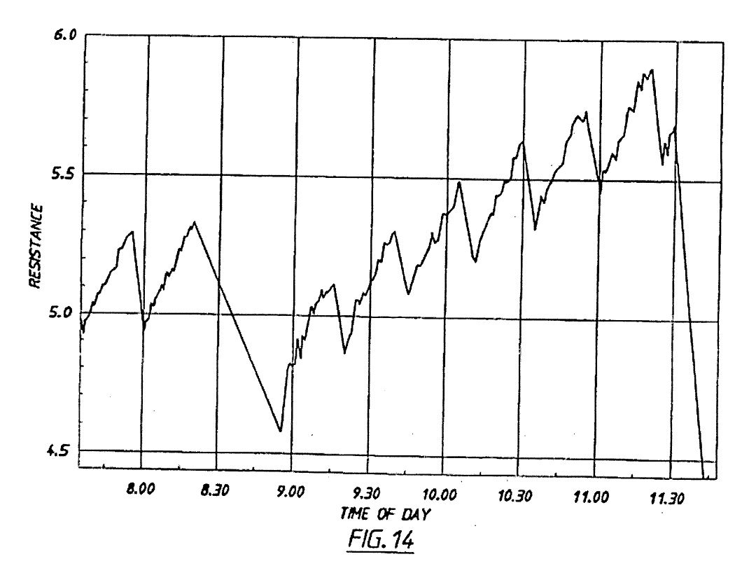

FIG. 14 illustrates the effect of scouring fully within the bundle as against scouring only the outer fibers. Again the beginning of the test shows a normal backwash regime with liquid backwash and gas scouring up until around 9:00. The gas scouring was then limited to the outside of the fiber bundle. The backwash efficiency again degraded dramatically from about 98% during normal operation to 58% with the restricted gas scouring.

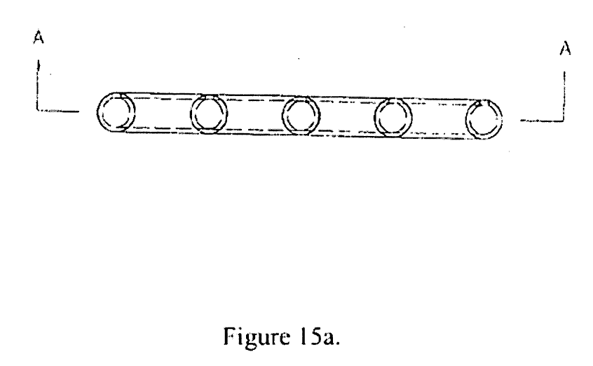

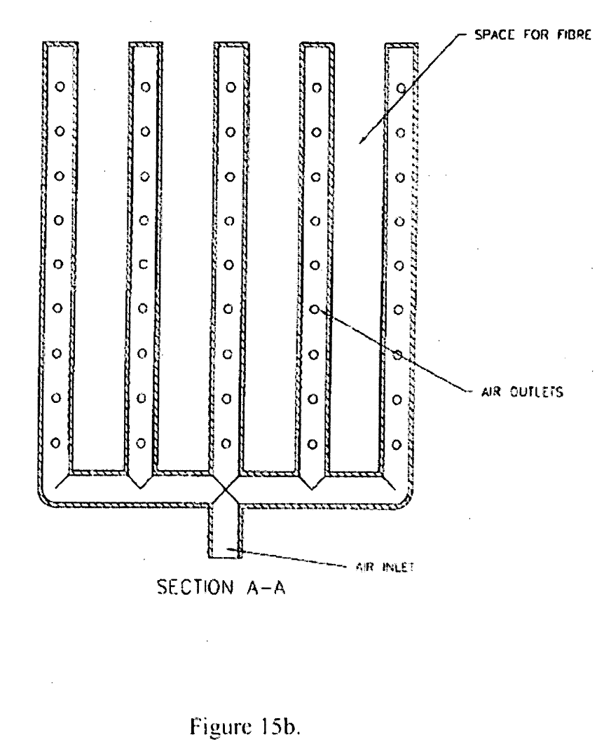

The gas bubbles employed for scrubbing, aeration, or other purposes can be provided from within the module by a variety of methods including gas distribution holes or openings in the header, a porous tube located within the module or a tube or tubes positioned to output gas within the module, the tubes can be in the form of a comb of tubes containing holes which sit within the module, as depicted, for example, in FIGS. 15a-c. Another method of providing gas bubbles includes creating gas in situ by means of spark type ozone generators or the like. Further types of gas provision are detailed below and in the preferred embodiments of the invention.

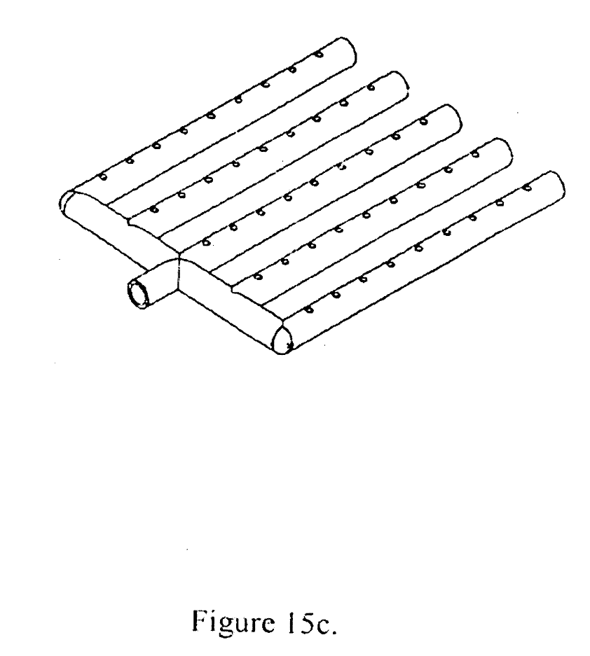

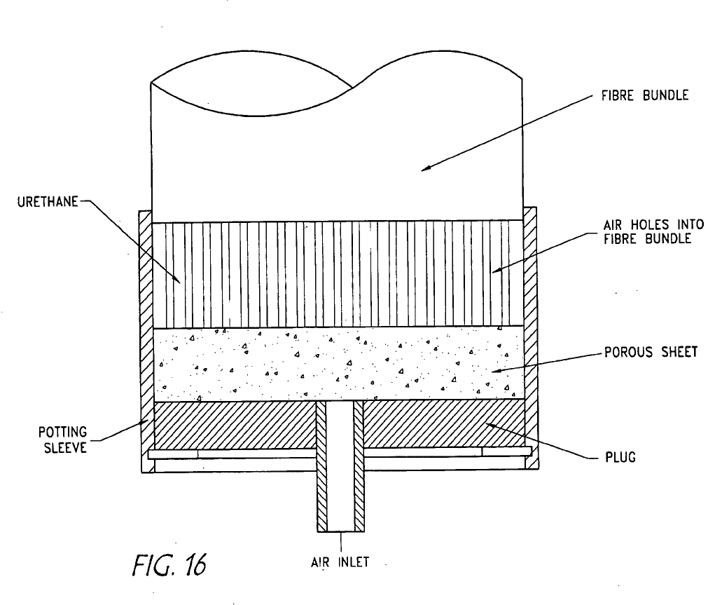

Filtrate is normally withdrawn from the fibers by application of suction applied thereto. However, it is appreciated that any suitable means of providing TMP can be used. A porous sheet can be used in conjunction with the holes or separately to provide a more uniform distribution of gas bubbles. A module incorporating a porous sheet is depicted in FIG. 16. The porous sheet also provides the added advantage of preventing solids ingressing into the air supply plenum chamber.

Optionally, when the module is contained in a separate vessel, periodic draindown of the vessel is carried out after the scouring step to remove solids accumulated during the scouring process. Apart from draindown, other methods can be used for accumulated solids removal. These include continual bleed off of concentrated feed during the filtration cycle or overflow at the top of the tank by pumping feed into the base of the tank at regular intervals at a rate sufficient to cause overflow and removal of accumulated solids. This is typically done at the end of a backwash cycle.

It should be understood that the term “gas” used herein includes any gas, including air and mixtures of gases as well as ozone and the like.

It is appreciated that the above described embodiments may be readily applied to our own modular microporous filter cartridges as used in our continuous microfiltration systems and described in our earlier U.S. Pat. No. 5,405,528. These cartridges can be modified by providing gas distribution holes in the lower plug and providing a manifold for supplying gas to the holes such that, in use, the gas passes through the holes and forms scouring bubbles which pass upward through the filter medium. In a preferred arrangement, the filter medium is sealed at the lower end and filtrate withdrawn under a vacuum from the upper end while the cartridge or cartridges were positioned in a tank containing the feed.

The preferred embodiments are described in relation to microporous fiber membranes, however, it is appreciated that the preferred embodiments are equally applicable to any form of membrane module.

The embodiments relate to membrane filtration systems and typically to a system using suction to produce transmembrane pressure, however, it is appreciated that the scouring system is equally applicable to any form of fiber membrane filtration process, including pressurized filtration systems.

The scouring process and method can be used in conjunction with any standard backwashing regimes including liquid backwashing, pressurized gas backwashing, combinations of both, as well as with chemical cleaning and dosing arrangements.

The scouring process is normally used in conjunction with the backwash stage, however, it can also be used continually during the filtration and backwash stages. Cleaning chemicals such as chlorine can be added to the gas providing the bubbles to further assist the scouring process. Solids removed in the scouring process can be intermittently or continually removed. With continual removal of solid a clarifier or the like can be used. The clarifier can be used in front of the module, in parallel with module or the module can be in the clarifier itself. Chemical dosing can be used in conjunction with the clarifier when required.

The filter system using such a scouring process can be used for sewage/biological waste treatment or combined with a bioreactor, activated sludge or similar system.

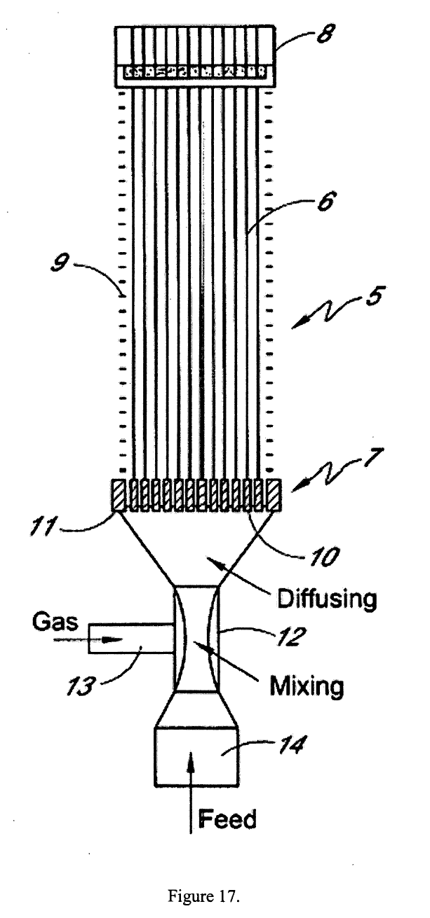

Depicted in FIG. 17 is a membrane module 5 comprising fiber, tubular, or flat sheet form membranes 6 potted at two ends 7 and 8 and optionally encased in a support structure, in this case a screen 9. Either one or both ends of the membranes can be used for the permeate collection. The bottom of the membrane module has a number of through apertures 10 in the pot 11 to distribute a mixture of gas and liquid feed past the membrane surfaces. A venturi device 12 or the like is connected to the base of the module. The venturi device 12 intakes gas through inlet 13, mixes or entrains the gas with liquid flowing through feed inlet 14, forms gas bubbles and diffuses the liquid/gas mix into the module apertures 10. After passing through the distribution apertures 10, the entrained gas bubbles scrub membrane surfaces while traveling upwards along with the liquid flow. Either the liquid feed or the gas can be a continuous or intermittent injection depending on the system requirements. With a venturi device it is possible to create gas bubbles and aerate the system without a blower. The venturi device 12 can be a venturi tube, jet, nozzle, ejector, eductor, injector, or the like.

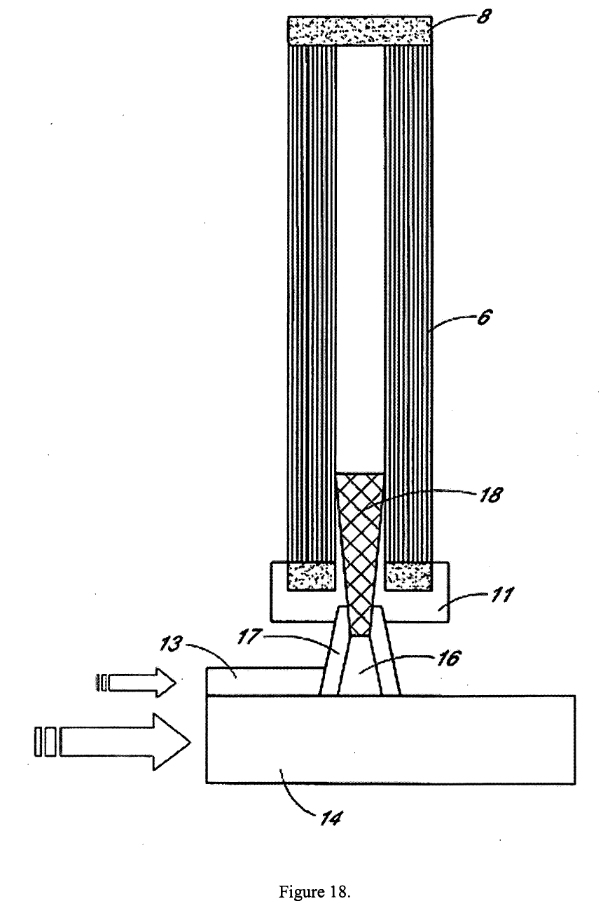

Referring to FIG. 18, an enlarged view of jet or nozzle type device 15 is shown. In this embodiment, liquid is forced through a jet 16 having a surrounding air passage 17 to produce a gas entrained liquid flow 18. Such a device allows the independent control of gas and liquid medium-by adjusting respective supply valves.

The liquid commonly used to entrain the gas is the feed water, wastewater, or mixed liquor to be filtered. Pumping such an operating liquid through a venturi or the like creates a vacuum to suck the gas into the liquid, or reduces the gas discharge pressure when a blower is used. By providing the gas in a flow of the liquid, the possibility of blockage of the distribution apertures 10 is substantially reduced.

By using a venturi device or the like it is possible to generate gas bubbles to scrub membrane surfaces without the need for a pressurized gas supply such as a blower. When a motive fluid passes through a venturi it generates a vacuum to draw the gas into the liquid flow and generate gas bubbles therein. Even if a blower is still required, the use of the above process reduces the discharge pressure of the blower and therefore lowers the cost of operation. The liquid and gas phases are well mixed in the venturi and then diffuse into the membrane module to scrub the membranes. Where a jet type device is used to forcibly mix the gas into the liquid medium, an additional advantage is provided in that a higher velocity of bubble stream is produced. In treatment of wastewater, such thorough mixing provides excellent oxygen transfer when the gas used is air or oxygen. If the gas is directly injected into a pipe filled with a liquid, it is impossible that the gas will form a stagnant gas layer on the pipe wall and therefore gas and liquid will bypass into different parts of a module, resulting in poor cleaning efficiency. The flow of gas bubbles is enhanced by the liquid flow along the membrane resulting in a large scrubbing shear force being generated. This method of delivery of gas/liquid provides a positive fluid transfer and aeration with the ability to independently adjust flow rates of gas and liquid.

The injection of a mixture of two-phase fluid (gas/liquid) into the holes of the air distribution device can eliminate the formation of dehydrated solids and therefore prevent the gradual blockage of the holes by such dehydrated solids. The injection arrangement further provides an efficient cleaning mechanism for introducing cleaning chemicals effectively into the depths of the module while providing scouring energy to enhance chemical cleaning. This arrangement, in combination with the high packing density obtainable with the module configuration described, enables the fibers to be effectively cleaned with a minimal amount of chemicals. The module configuration described allows a higher fiber packing density in a module without significantly increasing solid packing. This adds an additional flexibility that the membrane modules can be either integrated into the aerobic basin or arranged in a separate tank. In the latter arrangement, the advantage is a significant saving on chemical usage due to the small chemical holding in the tank and in labor costs because the chemical cleaning process can be automated. The reduction in chemicals used is also important because the chemicals, which can be fed back to the bio process, are still aggressive oxidizers and therefore can have a deleterious effect on bio process. Accordingly, any reduction in the chemical load present in the bio-process provides significant advantages.

The positive injection of a mixture of gas and liquid feed to each membrane module provides a uniform distribution of process fluid around membranes and therefore minimizes the feed concentration polarization during filtration. The concentration polarization is greater in a large-scale system and for the process feed containing large amounts of suspended solids. The prior art systems have poor uniformity because the process fluid often enters one end of the tank and concentrates as it moves across the modules. The result is that some modules deal with much higher concentrations than others, resulting in inefficient operation. The filtration efficiency is enhanced due to a reduced filtration resistance. The feed side resistance is decreased due to a reduced transverse flow passage to the membrane surfaces and the turbulence generated by the gas bubbles and the two-phase flow. Such a cleaning method can be used to the treatment of drinking water, wastewater, and water from industrial processes by membranes. The filtration process can be driven by suction or pressurization.

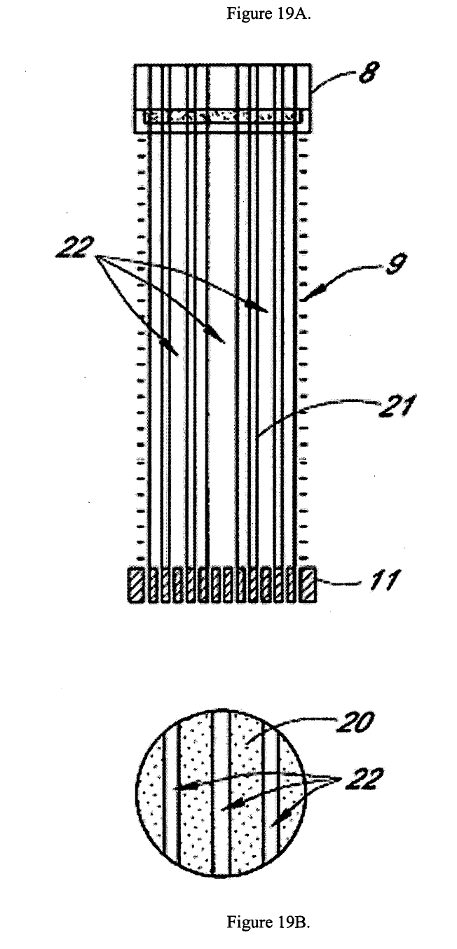

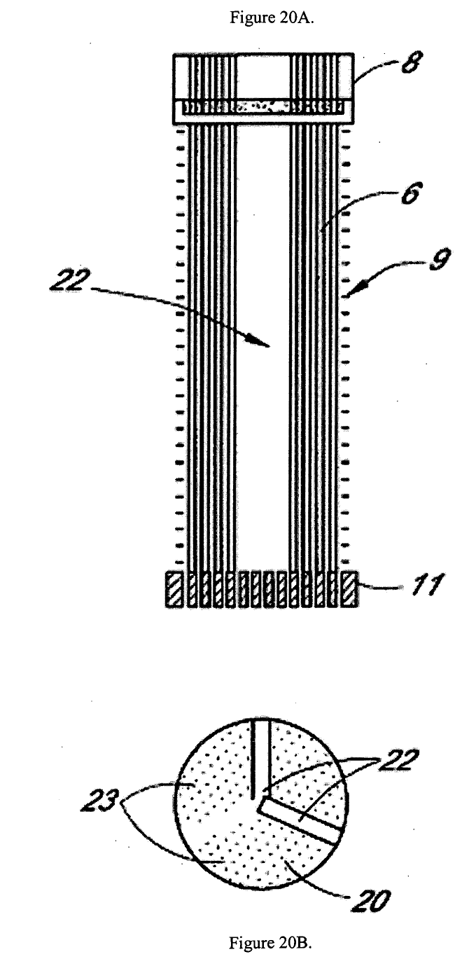

Referring to FIGS. 19A, 19B, 20A, and 20B, embodiments of various partitioning arrangements are shown. Again these embodiments are illustrated with respect to cylindrical tubular or fiber membrane bundles 20, however, it is appreciated that other configurations can be employed. FIGS. 19A and 19B show a bundle of tubular membranes 20 partitioned vertically into several thin slices 21 by a number of parallel partition spaces 22. This partitioning of the bundle enables accumulated solids to be removed more easily without significant loss of packing density. Such partitioning can be achieved during the potting process to form complete partitions or partial partitions. Another method of forming a partitioned module is to pot several small tubular membrane bundles 23 into each module as shown in FIGS. 20A and 20A.

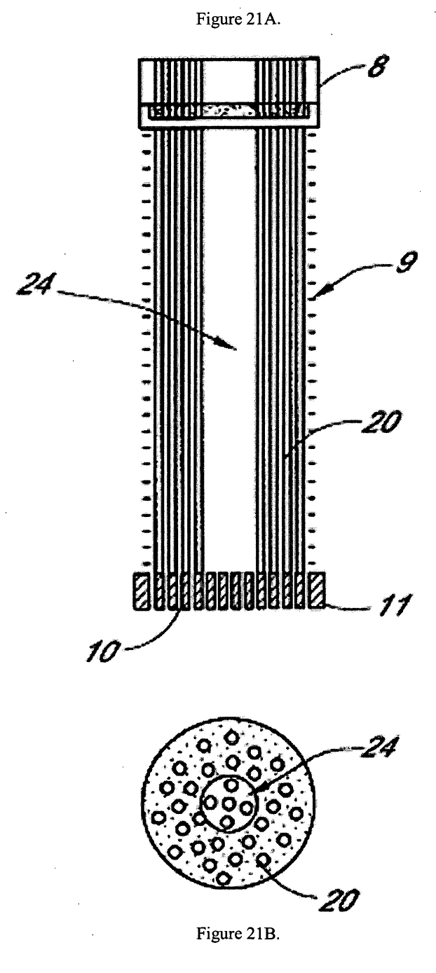

Another configuration of membrane module is illustrated in FIGS. 21A and 21B. The central membrane-free zone forms a passage 24 to allow for more air and liquid injection. The gas bubbles and liquid then travel along the tubular membranes 20 and pass out through arrays of fibers at the top potted head 8, scouring and removing solids from membrane walls. A single gas or a mixture of gas/liquid can be injected into the module.

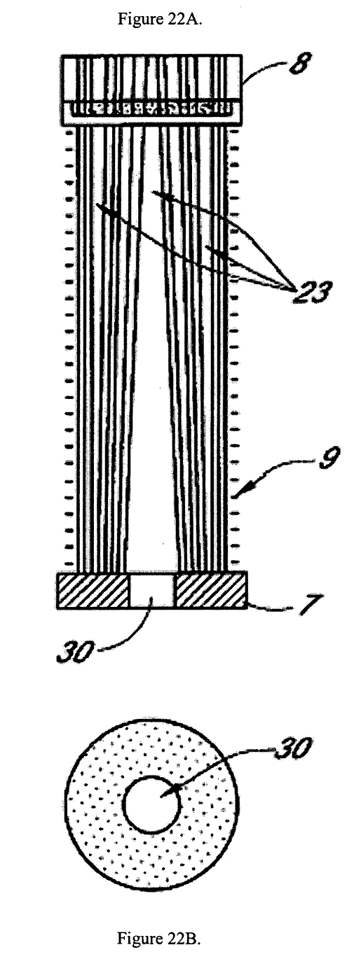

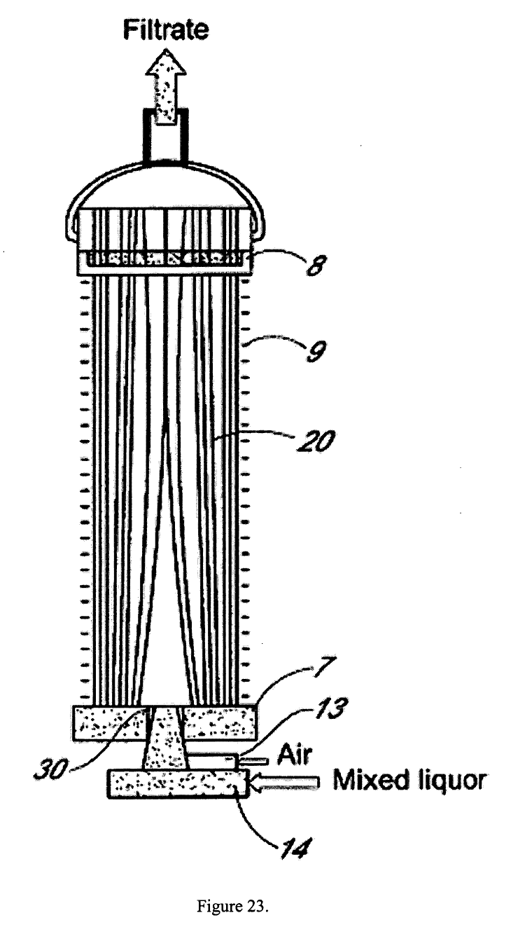

FIGS. 22A and 22B illustrate yet a further embodiment similar to FIG. 21 but with single central hole 30 in the lower pot 7 for admission of the cleaning liquid/gas mixture to the fiber membranes 20. In this embodiment, the fibers are spread adjacent the hole 30 and converge in discrete bundles 23 toward the top pot 8. The large central hole 30 has been found to provide greater liquid flow around the fibers and thus improved cleaning efficiency.

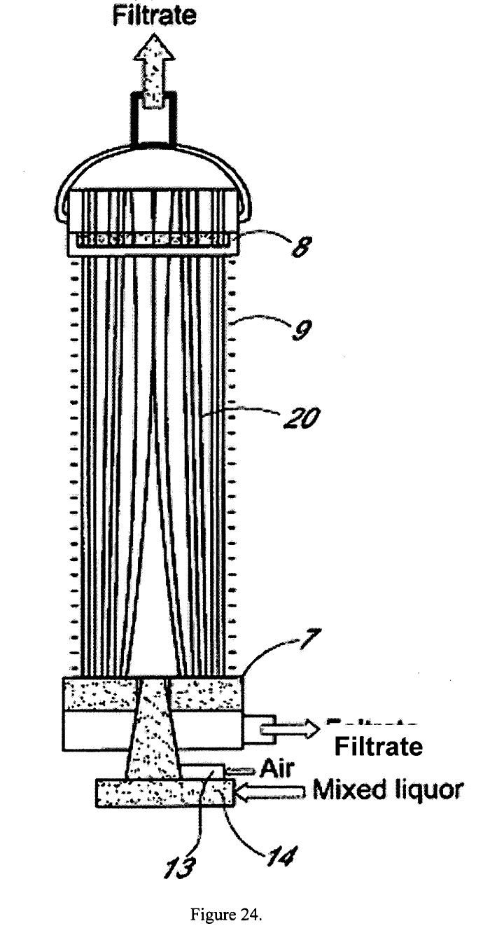

FIGS. 23 and 24 show further embodiments having a similar membrane configuration to that of FIGS. 22A and 22B and the jet mixing system similar to that of the embodiment of FIG. 18. The use of a single central hole 30 allows filtrate to drawn off from the fibers 20 at both ends as shown in Figure.

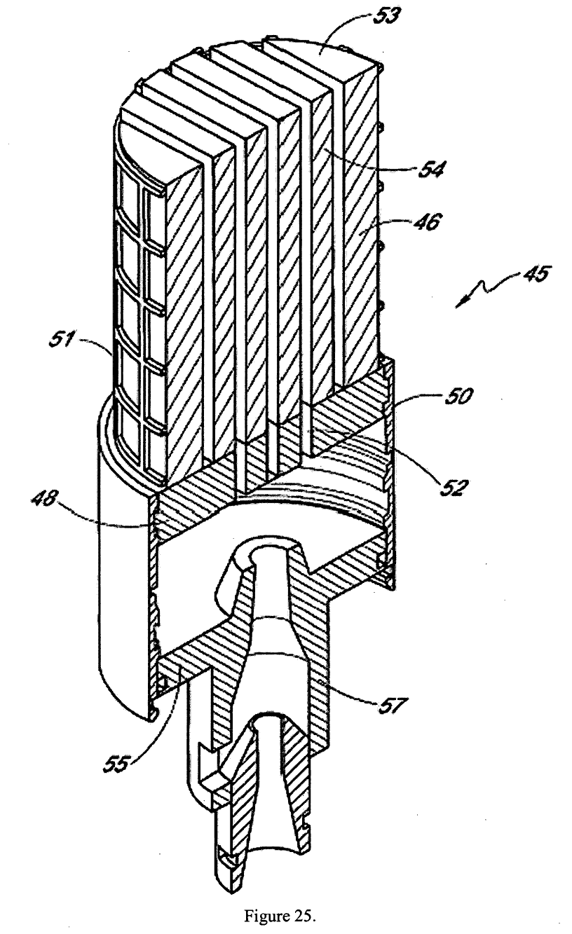

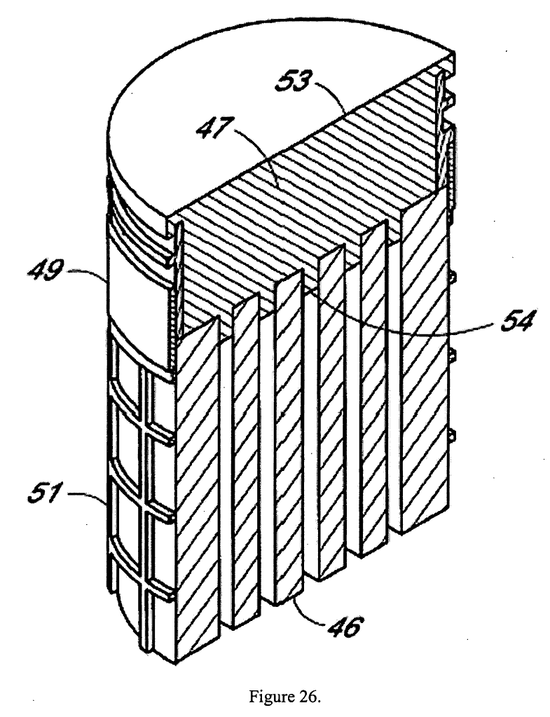

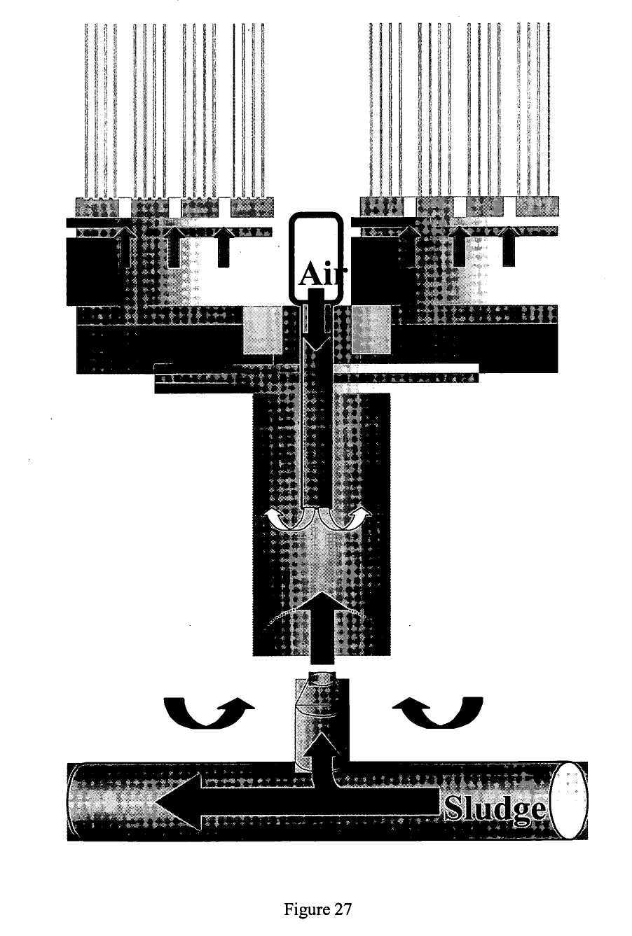

Referring to FIGS. 25 and 26, the module 45 comprises a plurality of hollow fiber membrane bundles 46 mounted in and extending between an upper 47 and lower potting head 8. The potting heads 47 and 48 are mounted in respective potting sleeves 49 and 50 for attachment to appropriate manifolding (not shown). The fiber bundles 46 are surrounded by a screen 51 to prevent excessive movement between the fibers.

As shown in FIG. 25, the lower potting head 48 is provided with a number of parallel arranged slot type aeration holes 52. The fiber membranes 53 are potted in bundles 46 to form a partitioned arrangement having spaces 54 extending transverse of the fiber bundles. The aeration holes 52 are positioned to generally coincide with the partition spaces, though there is generally a number of aeration holes associated with each space.

The lower potting sleeve 50 forms a cavity 55 below the lower pot 48. A gas or a mixture of liquid and gas is injected into this cavity 55, by a jet assembly 57 (described earlier) before passing through the holes 52 into the membrane array.

In use, the use of partitioning enables a high energy flow of scouring gas and liquid mixture, particularly near the pot ends of the fiber bundles, which assist with removal of buildup of accumulated solids around the membrane fibers.

Air is preferably introduced into the module continuously to provide oxygen for microorganism activities and to continuously scour the membranes. Alternatively, in some embodiments, pure oxygen or other gas mixtures can be used instead of air. The clean filtrate is drawn out of the membranes by a suction pump attached to the membrane lumens that pass through the upper pot, or the filtrate can be drawn out of the membranes from the lower pot by gravity or suction pump.

Preferably, the membrane module is operated under low transmembrane pressure (TMP) conditions due to the high concentration of suspended solids (MLSS) present in the reactor. Higher transmembrane pressure can advantageously be employed for reduced concentrations of suspended solids.

The membrane bioreactor is preferably combined with an anaerobic process that assists with further removal of nutrients from the feed sewage. It has been found that the module system of preferred embodiments is more tolerant of high MLSS than many other systems and the efficient air scrub and back wash (when used) assists efficient operation and performance of the bioreactor module.

Any suitable membrane bioreactor can be employed in the water treatment systems of the preferred embodiments. A particularly preferred membrane bioreactor system is designed to draw filtrate from a reservoir of liquid substrate by the use of vertically oriented microporous hollow fibers immersed within the substrate, as illustrated in FIG. 27. FIG. 27 depicts a side view of a so-called “cloverleaf” filtration unit comprising four sub-modules. A plurality of such filtration units in a linear “rack” is immersed in a substrate reservoir.

The illustrated membrane bioreactor filtration unit includes a filtrate sub-manifold (not shown) and an air/liquid substrate sub-manifold, which receive the upper and lower ends, respectively, of the four sub-modules. Each sub-manifold includes four circular fittings or receiving areas, each of which receives an end of one of the sub-modules. Each sub-module is structurally defined by a top cylindrical pot (not shown), a bottom cylindrical pot, and a cage (not shown) connected therebetween to secure the fibers. The pots secure the ends of the hollow fibers and are formed of a resinous or polymeric material. The ends of the cage are fixed to the outer surfaces of the pots. Each pot and associated end of the cage are together received within one of the four circular fittings of each sub-manifold. The sub-manifolds and pots of the sub-modules are coupled together in a fluid-tight relationship with the aid of circular clips and O-ring seals. The cage provides structural connection between the pots of each sub-module.

Each sub-module includes fibers arranged vertically between its top and bottom pot. The fibers have a length somewhat longer than the distance between the pots, such that the fibers can move laterally. The cage closely surrounds the fibers of the sub-module so that, in operation, the outer fibers touch the cage, and lateral movement of the fibers is restricted by the cage. The lumens of the lower ends of the fibers are sealed within the bottom pot, while the upper ends of the fibers are not sealed. In other words, the lumens of the fibers are open to the inside of the filtrate sub-manifold above the upper face of the top pot. The bottom pot includes a plurality of slots extending from its lower face to its upper face, so that the mixture of air bubbles and liquid substrate in the air/liquid substrate sub-manifold can flow upward through the bottom pot to be discharged between the lower ends of the fibers.

The filtrate sub-manifold is connected to a vertically oriented filtrate withdrawal tube that in turn connects to a filtrate manifold (not shown) that receives filtrate from all of the filtration units (such as the illustrated cloverleaf unit) of a rack. The filtrate withdrawal tube is in fluid communication with the upper faces of the top pots of the sub-modules, so that filtrate can be removed through the withdrawal tube. In addition, the system includes an air line that provides air to the air/liquid substrate sub-module skirt, as depicted in FIG. 27.

In operation, the cages of the sub-modules admit the liquid substrate into the region of the hollow fibers, between the top and bottom pots. A pump (not shown) is utilized to apply suction to the filtrate manifold and, thus, the filtrate withdrawal tubes and fiber lumens of the sub-modules. This creates a pressure differential across the walls of the fibers, causing filtrate to pass from the substrate into the lumens of the fibers. The filtrate flows upward through the fiber lumens into the filtrate sub-manifold, through the filtrate withdrawal tube, and upward into the filtrate manifold to be collected outside of the reservoir.

### Scouring Process

During filtration, particulate matter accumulates on the outer surfaces of the fibers. As increasing amounts of particulate matter stick to the fibers, it is necessary to increase the pressure differential across the fiber walls to generate sufficient filtrate flow. To maintain cleanliness of the outer surfaces of the fibers, air and liquid substrate are mixed in the skirt of the air/liquid substrate sub-module and the mixture is then distributed into the fiber bundles through the slots of the bottom pots and is discharged as a bubble-containing mixture from the upper faces of the bottom pots.

Continuous, intermittent, or cyclic aeration can be conducted. It is particularly preferred to conduct cyclic aeration, wherein the air on and air off times are of equal length, and the total cycle time is from about 1 second or less to about 15 minutes or more, preferably from about 2, 3, 4, 5, 6, 7, 8, 9, 10, 11, 12, 13, or 14 second to about 6, 7, 8, 9, 10, 11, 12, 13, or 14 minutes, and more preferably from about 15, 20, 25, 30, 35, 40, 45, 50, 55, 60, 65, 70, 75, 80, 85, 90, 95, 100, 105, 110, 115, 120, or 125 seconds to about 130, 140, 150, 160, 170, 180, 190, 200, 210, 220, 230, 240, 250, 260, 270, 280, 290, or 300 seconds.

A cycle is defined as one “air on” period followed by one “air off” period (or vice versa), or one period of higher flow followed by one period of lower flow (or vice versa). The cycle is repeated as many times as desired. A cycle of 180 seconds can comprise a period of 90 seconds of “air on”, followed by 90 seconds of “air off”, for example. Another example of a cycle 180 duration is 100 seconds of “air on”, followed by 80 seconds of “air off”. A series of identical cycles can be repeated (e.g., 90 seconds “air on”, followed by 90 seconds “air off”, followed by 90 seconds “air on”, followed by 90 seconds “air off”, etc.), or different cycles can be performed in sequence (e.g., 90 seconds “air on”, followed by 90 seconds “air off”, followed by 100 seconds “air on”, followed by 100 seconds “air off”, followed by 90 seconds “air on”, followed by 90 seconds “air off”, followed by 90 seconds “air on”, followed by 90 seconds “air off”, etc.). As is appreciated by one skilled in the art, many different cycle configurations can be employed.

The rising bubbles scour (i.e., clean particulate matter from) the fiber surfaces. Aeration wherein the air is provided in uniform bubble sizes can be provided, or a combination of different bubble sizes can be employed, for example, coarse bubbles or fine bubbles, simultaneously or alternately. Regular or irregular cycles (in which the air on and air off times vary) can be employed, as can sinusoidal, triangular, or other types of cycles, wherein the rate of air is not varied in a discontinuous fashion, but rather in a gradual fashion, at a preferred rate or varying rate. Different cycle parameters can be combined and varied, as suitable.

In a particularly preferred embodiment, fine bubbles are continuously provided to the membrane bioreactor for aeration, while coarse bubbles are provided cyclically for scouring. Bubbles are typically from about 0.1 or less to about 50 mm or more in diameter. Bubbles from about 0.1 to about 3.0 mm in diameter, preferably from about 0.2, 0.3, 0.4, 0.5, 0.6, 0.7, 0.9, 0.9, or 1.0 mm to about 1.25, 1.50, 1.75, 2.00, 2.25, 2.50 or 2.75 mm in diameter are particularly effective in providing oxygen to the bioreactor. Bubbles of from about 20 to about 50 mm in diameter, preferably from about 25, 30, or 35 to about 40 or 45 mm in diameter, are particularly effective in scouring the membranes. Bubbles of from about 3 to about 20 mm in diameter, preferably from about 4, 5, 6, 7, 8, 9, or 10 mm to about 11, 12, 13, 14, 15, 16, 17, 18, or 19 mm in diameter, are generally preferred as providing both acceptable oxygenation and scouring.

It is generally preferred to provide air or another gas to the aerators or aeration source at a superficial velocity in relation to the aeration source of from about 0.001 m/s or less to about 1 m/s or more, preferably from about 0.002, 0.003, 0.004, 0.005, 0.006, 0.007, 0.008, or 0.009, 0.010, 0.011, 0.012, 0.013, or 0.014 m/s to about 0.16, 0.17, 0.18, 0.19, 0.20, 0.25, 0.30, 0.35, 0.40, 0.45, 0.50, 0.55, 0.60, 0.65, 0.70, 0.75, 0.80, 0.85, 0.90, or 0.95 m/s, and more preferably from about 0.015, 0.020, 0.025, 0.030, 0.035, 0.040, 0.045, 0.050, 0.055, 0.060, 0.065, 0.070, 0.075, 0.080, 0.085, 0.090, or 0.095 to about 0.10, 0.11, 0.12, 0.13, 0.14, or 0.15 m/s.

It is generally preferred to provide aeration to an membrane bioreactor operated in aerobic mode at a rate of from about 1 L/m²/hr or less to about 1000 L/m²/hr or more, preferably from about 2, 3, 4, 5, 6, 7, 8, 9, 10, 11, 12, 13, 14, 15, 16, 17, 28, 29, 20, 21, 22, 23, 24, or 25 L m²/hr to about 300, 350, 400, 450, 500, 550, 600, 650, 700, 750, 800, 850, 900, or 950 L/m²/hr, and more preferably from about 30, 31, 32, 33, 34, 35, 36, 37, 38, 39, 40, 41, 42, 43, 44, 45, 46, 47, 48, 49, or 50 L/m²/hr to about 55, 60, 65, 70, 75, 80, 85, 90, 95, 100, 125, 150, 175, 200, 225, 250, or 275 L/m²/hr.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that can vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method of aerating a membrane module immersed in a liquid substrate comprising the step of:
providing a flow of air to an aeration source below the membrane module, the flow of air alternating between a higher flow rate and a lower flow rate in repeated cycles of from greater than about 120 seconds to less than about 300 seconds in duration.

2. The method of claim 1, wherein the repeated cycles are from about 130 seconds to about 250 seconds in duration.

3. The method of claim 1, wherein the repeated cycles are from about 140 seconds to about 225 seconds in duration.

4. The method of claim 1, wherein the repeated cycles are from about 150 seconds to about 210 seconds in duration.

5. The method of claim 1, wherein the repeated cycles are from about 160 seconds to about 200 seconds in duration.

6. The method of claim 1, wherein the repeated cycles are from about 170 seconds to about 190 seconds in duration.

7. The method of claim 1, wherein the repeated cycles are about 180 seconds in duration.

8. The method of claim 1, wherein the flow of air produces transient flow conditions in the liquid substrate.

9. The method of claim 1, wherein the flow of air accelerates or decelerates the liquid substrate for much of the cycle so that the liquid substrate is rarely in a steady state.

10. The method of claim 1, wherein the aeration source comprises an aerator.

11. The method of claim 1, wherein the aeration source comprises perforated sheet.

12. The method of claim 1, wherein the aeration source comprises a jet.

13. The method of claim 1, wherein the aeration source is integral with the membrane module.

14. The method of claim 1, wherein the aeration source is separate from the membrane module.

15. The method of claim 1, wherein the lower flow rate is an air off condition.

16. The method of claim 1, wherein the lower flow rate is less than 25% of the higher flow rate.

17. The method of claim 1, wherein the lower flow rate is less than 40% of the higher flow rate.

18. The method of claim 1, wherein the lower flow rate is less than 50% of the higher flow rate.

19. The method of claim 1, wherein the lower flow rate is less than 75% of the higher flow rate.

20. The method of claim 1, wherein a plurality of membrane modules are aerated.

21. The method of claim 1, wherein the liquid substrate comprises water.

22. The method of claim 1, wherein the membrane module is immersed in a tank.

23. The method of claim 1, wherein the higher flow rate corresponds to a superficial velocity in relation to the aeration source receiving the flow of air of from about 0.005 m/s to about 0.5 m/s.

24. The method of claim 1, wherein the higher flow rate corresponds to a superficial velocity in relation to the aeration source receiving the flow of air of from about 0.010 m/s to about 0.2 m/s.

25. The method of claim 1, wherein the higher flow rate corresponds to a superficial velocity in relation to the aeration source receiving the flow of air of from about 0.015 m/s to about 0.15 m/s.
